(19) United States
(12) Patent Application Publication
(10) Pub. No.: US 2014/0189892 A1
(43) Pub. Date: Jul. 3, 2014

(54) COMMUNICATION DEVICE AND COMMUNICATION SYSTEM

(71) Applicant: Kabushiki Kaisha Toshiba, Tokyo (JP)

(72) Inventor: Prashob Ramachandran Nair, Tokyo (JP)

(73) Assignee: Kabushiki Kaisha Toshiba, Tokyo (JP)

(21) Appl. No.: 14/013,987

(22) Filed: Aug. 29, 2013

Related U.S. Application Data
(63) Continuation of application No. PCT/JP2013/058425, filed on Mar. 22, 2013.

(30) Foreign Application Priority Data
Dec. 28, 2012 (JP) 2012-288216

(51) Int. Cl. G06F 21/81

(52) U.S. Cl. CPC G06F 21/81
USPC 726/36

(57) ABSTRACT

According to one embodiment, a communication device includes a detector, a power controller and an authentication module. The detector is configured to detect connection of a source device. The authentication module is configured to perform authentication of the source device based on authentication data. The power controller is configured to continue supplying power to the source device when the authentication of the source device is successfully completed.

### CROSS-REFERENCE TO RELATED APPLICATIONS

This application is a continuation of International Application No. PCT/JP2013/058425, filed on Mar. 22, 2013 which claims the benefit of priority of the prior Japanese Patent Application No. 2012-288216, filed on Dec. 28, 2012, the entire contents of which are incorporated herein by reference.

### FIELD

Embodiments described herein relate generally to a communication device and a communication system.

### BACKGROUND

In recent years, mobile devices capable of displaying high-definition video have been widely used. To deal with such sophisticated functions of the mobile devices, for example, a video transmission technology based on the Mobile High-Definition Link (MHL) standard or the like has been developed.

In the video transmission technology based on the standard as described above, it is possible to supply power from a sink device, such as a television device, to a source device, such as a mobile device, through a cable.

However, the sink device starts supplying power even when the source device is not connected to a connector at one end of the cable while the sink device is connected to a connector at the other end of the cable, so that the power is wasted.

Furthermore, when the source device is connected to the connector of the cable, power is supplied without conditions, so that an invalid device maybe connected and used as the source device. Therefore, it is desired to enhance the security.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary configuration diagram of a communication system according to an embodiment;

FIG. 2 is an exemplary configuration diagram of a cable according to the embodiment;

FIG. 3 is an exemplary block diagram illustrating a configuration of a digital television according to the embodiment;

FIG. 4 is an exemplary block diagram illustrating a functional configuration of a controller of the digital television according to the embodiment;

FIG. 5 is an exemplary state transition diagram of the digital television according to the embodiment;

FIG. 6 is an exemplary flowchart illustrating the flow of a power control process according to the embodiment;

FIG. 7 is an exemplary diagram illustrating a time chart when power supply is continued in the embodiment;

FIG. 8 is an exemplary diagram illustrating a time chart when power supply is stopped due to an authentication failure in the embodiment; and

FIG. 9 is an exemplary diagram illustrating a time chart when power supply is stopped due to expiry of a timer period.

### DETAILED DESCRIPTION

In general, according to one embodiment, a communication device is connectable to a source device and comprises a detector, a power controller and an authentication module. The detector is configured to detect connection of the source device by detecting an on-state of a connector. The connector is configured to mechanically enter the on-state upon connection of the source device. The power controller is configured to start supplying power to the source device through a cable when the connection of the source device is detected. The authentication module is configured to perform authentication of the source device based on authentication data received from the source device after the power supply is started. The power controller is configured to continue supplying power to the source device when the authentication of the source device is successfully completed.

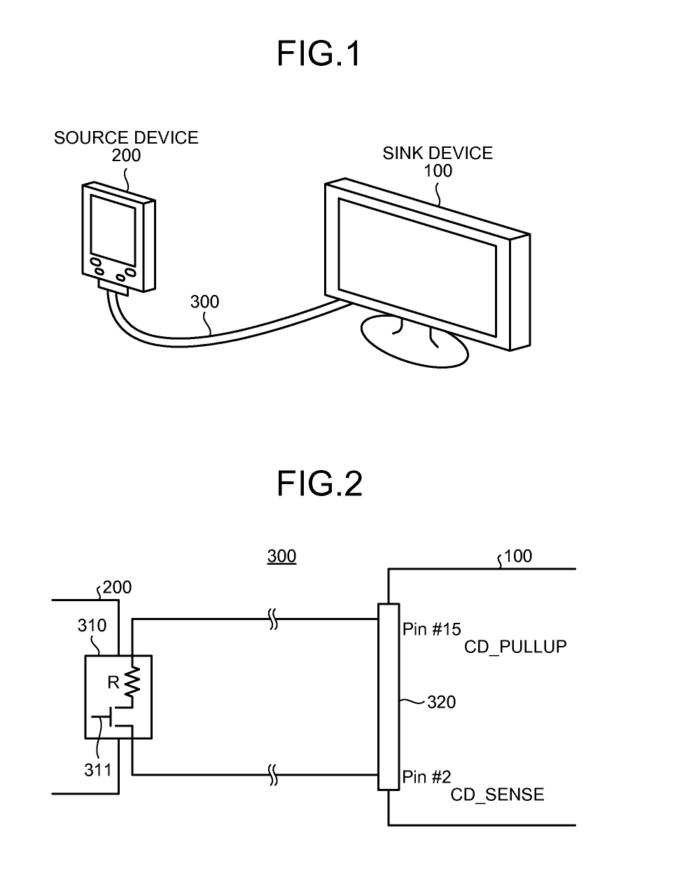

A communication device and a communication system according to one embodiment will be described in detail below with reference to the accompanying drawings. The communication system of the embodiment comprises, as illustrated in FIG. 1, a mobile device 200 and a digital television 100 that are connected to each other through a Mobile High-Definition Link (MHL) cable 300.

In the embodiment, video transmission between the mobile device 200 and the digital television 100 is implemented in conformity with the MHL standard. More specifically, in the embodiment, the mobile device 200 serves as a source device while the digital television 100 serves as a sink device, and the mobile device 200 transmits video data to the digital television 100 through the MHL cable 300 by using a protocol based on the MHL standard.

In the embodiment, the digital television 100 comprising a reception tuner for digital broadcasting will be explained as an example of the communication device. However, the communication device is not limited to the digital television 100, and may be any device such as a hard disk recorder or a set-top box that comprises a tuner for receiving broadcast waves and that is configured to process video and output the video to an externally-connected display device. Alternatively, the communication device may be any device such as a monitor that does not comprise a tuner and that is configured to receive video and audio from an external tuner. Furthermore, devices other than the digital television 100 or other than the devices such as a hard disk recorder and a set-top box may be employed as the communication device.

In addition, while the mobile device 200 serves as the source device and the digital television 100 serves as the sink device in the embodiment, this is described by way of example only, and the embodiment is not limited to this combination. Furthermore, the sink device is not limited to the mobile device 200.

The MHL cable 300 of the embodiment comprises, as illustrated in FIG. 2, a connector 310 and a connector 320. The connector 310 connects the mobile device 200 serving as the source device, and the connector 320 connects the digital television 100 serving as the sink device. The connector 320 of the embodiment is a receptacle based on the High-Definition Multimedia Interface (HDMI) Type A.

The connector 310 for connecting the source device comprises a resistance R and a mechanical switch 311. The mechanical switch 311 is turned off while the connector 310 is disconnected from the source device. The mechanical switch 311 is mechanically turned on upon connection of the connector 310 to the source device, so that electrical continuity is established between a CD_PULLUP signal line connected to a Pin#15 and a CD_SENSE signal line connected to a Pin#2 in the connector 320 on the sink device side and the voltage drops due to the resistance R. The conduction state is detected as an ON signal from the CD_SENSE signal line on the digital television 100 side, and when the ON signal is detected, it is determined that the source device is connected to the connector 310. With the mechanical switch 311 as described above, it becomes possible to detect connection of the source device to the connector 310 of the MHL cable even when power is not supplied to the source device.

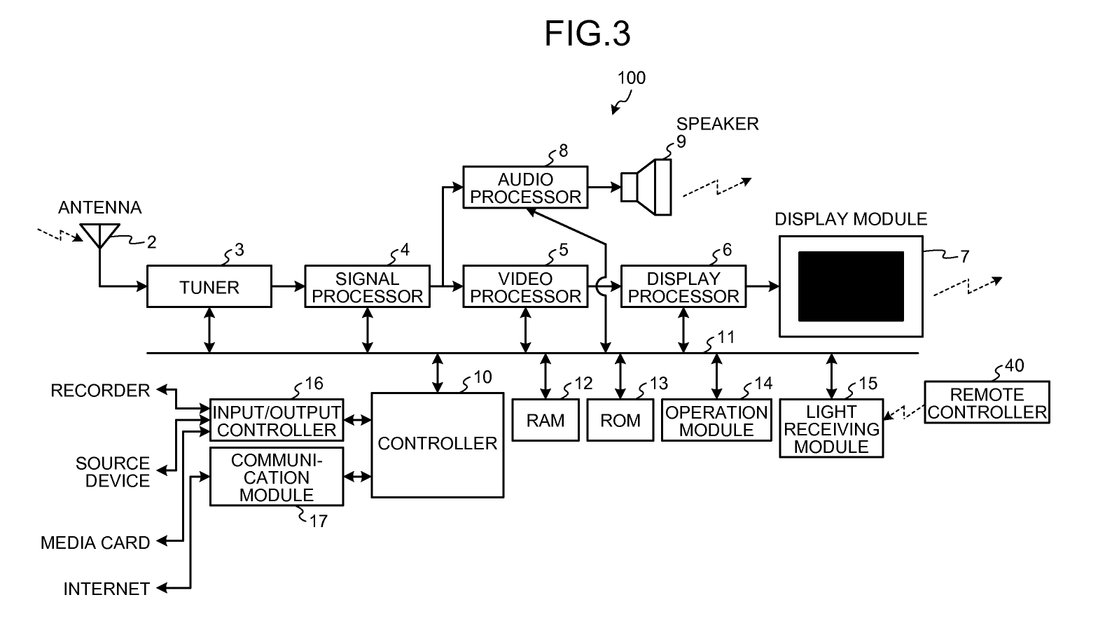

The digital television 100 of the embodiment will be explained below. The digital television 100 of the embodiment mainly comprises, as illustrated in FIG. 3, an antenna 2, a tuner 3 for receiving digital broadcasting, a signal processor 4, a video processor 5, a display processor 6, a display module 7, an audio processor 8, a speaker 9, a controller 10, a communication line 11, a random access memory (RAM) 12, a read-only memory (ROM) 13, an operation module 14, a light receiving module 15, an input/output controller 16, and a communication module 17.

The antenna 2 receives digital broadcasting, such as BS, CS, or terrestrial broadcasting. The tuner 3 selects a viewing channel designated by a user. The signal processor 4 extracts and processes, as various digital signals, a signal demodulated by the tuner 3 and a signal input by the input/output controller 16 under the control of the controller 10. The signal processor 4 separates the input signal into a video signal and an audio signal, outputs the video signal to the video processor 5, and outputs the audio signal to the audio processor 8.

The video processor 5 performs a process for adjusting the video signal input by the signal processor 4 to a correct screen size, a process for removing noise from the video signal as image quality processing for improving the image quality of video, or the like.

The display processor 6 performs a process for displaying the video signal output by the video processor 5 on the display module 7. The display processor 6 superimposes an on-screen display (OSD), such as textual information, on the video signal output by the video processor 5. The display module 7 displays the video signal on the screen. The user watches television images by watching the screen of the display module 7.

The audio processor 8 performs sound processing on the audio signal and amplifies the audio signal. The speaker 9 outputs the audio signal as sound. The user listens to television audio by listening to the sound from the speaker 9.

The controller 10 controls each of the modules of the digital television 100. The controller 10 is a processing unit capable of performing sequential processing. The controller 10 loads the programs stored in the ROM 13 into the RAM 12, and sequentially executes the programs to output control signals to each of the modules of the digital television 100 to thereby centrally control the operation of the digital television 100.

The communication line 11 connects the tuner 3, the signal processor 4, the video processor 5, the display processor 6, the audio processor 8, and the controller 10 to one another, and enables data exchange between the controller 10 and each of the tuner 3, the signal processor 4, the video processor 5, the display processor 6, and the audio processor 8. Specifically, the communication line 11 may be an inter-integrated circuit bus (IIC-BUS) for example. The RAM 12 and the ROM 13 store therein various types of data and exchange the data with the controller 10.

The operation module 14 is a switch for receiving an operating instruction from a user. The light receiving module 15 receives a signal sent by a remote controller 40 (hereinafter, simply referred to as “the remote 40”) that has received the operating instruction from the user. The user can operate the digital television 100 and various devices connected to the digital television 100 by operating various buttons or keys of the remote 40.

The communication module 17 has a function to communicate with a server connected via a network, such as the Internet. The communication module 17 sends a request for information to the server and receives the information transmitted by the server.

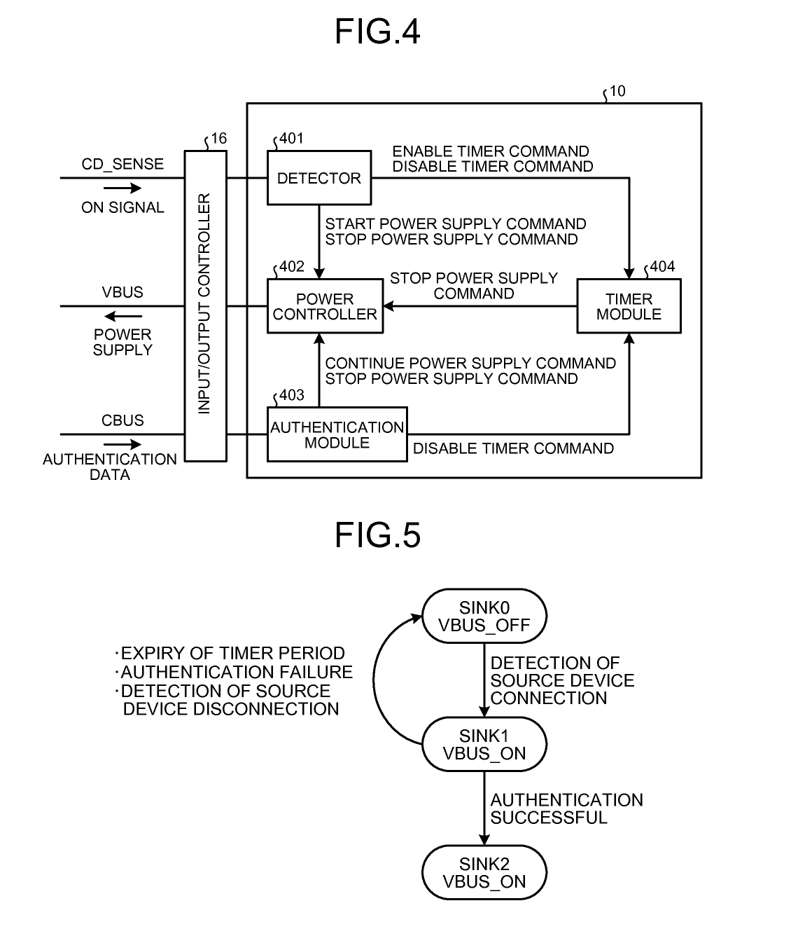

The functions implemented by the controller 10 will be explained in detail below. As illustrated in FIG. 4, the digital television 100 mainly comprises, as a functional configuration realized by the controller 10, a detector 401, a power controller 402, an authentication module 403, and a timer module 404. In FIG. 4, the input/output controller 16 illustrated in FIG. 3 is also illustrated for convenience of explanation.

The detector 401 monitors the CD_SENSE signal line of the MHL cable 300 at regular time intervals. When receiving the ON signal indicating the conduction state of the connector 310 from the CD_SENSE signal line, the detector 401 detects that the source device is connected to the connector 310 of the MHL cable 300. When detecting the connection of the source device, the detector 401 sends a start power supply command to the power controller 402 and sends an enable timer command to the timer module 404.

The detector 401 detects that the source device is connected while receiving the ON signal from the CD_SENSE signal line by monitoring at regular time intervals, and detects that the source device gets detached and disconnected from the connector 310 of the MHL cable 300 when not receiving the ON signal. When detecting the disconnection of the source device, the detector 401 sends a stop power supply command to the power controller 402 and sends a disable timer command to the timer module 404.

When receiving the enable timer command from the detector 401, that is, when the detector 401 detects the connection of the source device, the timer module 404 starts measuring a predetermined timer period.

Furthermore, when receiving the disable timer command from the detector 401, that is, when the detector 401 detects the disconnection of the source device, the timer module 404 stops measuring the timer period. Moreover, when receiving the disable timer command from the authentication module 403 to be described later, that is, when authentication by the authentication module 403 is successfully completed, the timer module 404 stops measuring the timer period.

When the timer period has expired, the timer module 404 sends a stop power supply command to the power controller 402. The case where the timer period has expired is a case where authentication data is not received from the source device within the timer period and the authentication module 403 (to be described later) does not perform the authentication process on the source device.

The authentication module 403 receives the authentication data (wake and discovery pulse) from the source device through a control line (CBUS) of the MHL cable 300 after the power supply has started, and performs authentication of the source device connected to the MHL cable 300 based on the authentication data. A well-known method may be employed as the authentication method. When the authentication of the source device is successfully completed, the authentication module 403 sends a continue power supply command to the power controller 402 and sends the disable timer command to the timer module 404 in order to reset the timer period to be measured.

On the other hand, when the authentication of the source device fails, the authentication module 403 sends the stop power supply command to the power controller 402.

The power controller 402 controls power supply to the source device. The power controller 402 supplies power to the source device through a power source line (VBUS) of the MHL cable 300 via the input/output controller 16.

More specifically, when the detector 401 detects connection of the source device and the power controller 402 receives the start power supply command from the detector 401, the power controller 402 starts supplying power to the source device. When the detector 401 detects disconnection of the source device and the power controller 402 receives the stop power supply command from the detector 401, the power controller 402 stops supplying power to the source device.

When the authentication of the source device is successfully completed and the power controller 402 receives the continue power supply command from the authentication module 403, the power controller 402 continues supplying power to the source device.

On the other hand, when the authentication of the source device fails and the power controller 402 receives the stop power supply command from the authentication module 403, the power controller 402 stops supplying power to the source device. When the timer period has expired since the start of the power supply before the power controller 402 receives the authentication data from the authentication module 403, and when the power controller 402 receives the stop power supply command from the timer module 404, the power controller 402 stops supplying power to the source device.

Along with the above operation, the state of the sink device (the digital television 100) changes as described below. The sink device has three states SINK 0 to SINK 2. SINK 0 is a state in which power is not supplied to the source device (VBUS_OFF). SINK 1 is a state in which the power supply is started (VBUS_ON). SINK 2 is a state in which power is continuously supplied to the source device (VBUS_ON).

As illustrated in the state transition diagram in FIG. 5, when connection of the source device is detected while the sink device is in the SINK 0 state, the sink device moves to the SINK 1 state and starts supplying power to the source device.

When the authentication module 403 has successfully completed the authentication of the source device while the sink device is in the SINK 1 state, the sink device moves to the SINK 2 state as illustrated in FIG. 5. On the other hand, when the timer period has expired with no authentication data from the source device while the sink device is in the SINK 1 state, or when the authentication module 403 has failed the authentication of the source device, or when the detector 401 detects disconnection of the source device, the sink device moves to the SINK 0 state as illustrated in FIG. 5.

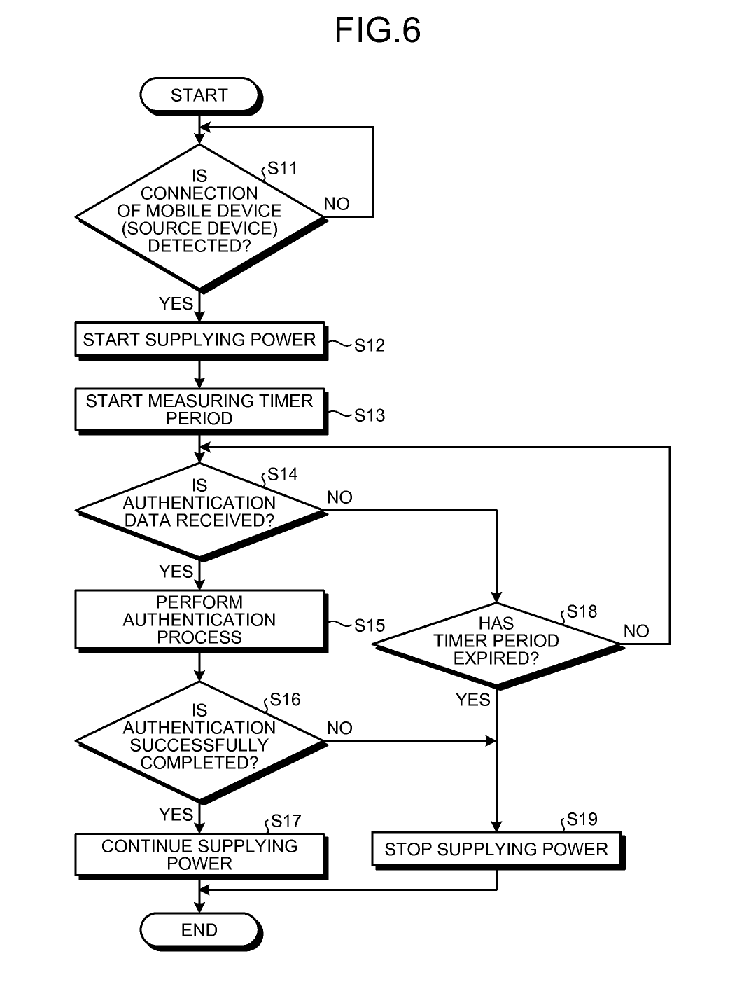

With reference to FIG. 6, a power supply control process performed by the digital television 100 serving as the sink device with the above configuration of the embodiment will be described below. The detector 401 monitors the CD_SENSE signal line and detects whether or not the mobile device 200 serving as the source device is connected to the MHL cable 300 (Step S11).

When detecting connection of the mobile device 200 (YES at Step S11), the detector 401 sends the start power supply command to the power controller 402, and the power controller 402 starts supplying power to the mobile device 200 through the power source line (VBUS) (Step S12). Furthermore, the detector 401 sends the enable timer command to the timer module 404, and the timer module 404 sets a timer period and activates a timer to start measuring the timer period in response to the command (Step S13). Incidentally, the detector 401 monitors the CD_SENSE signal line at predetermined time intervals in parallel with the subsequent processes. When the detector 401 detects disconnection of the mobile device 200 because of non-detection of the ON signal from the CD_SENSE signal line, the detector 401 sends the stop power supply command to the power controller 402, and the power controller 402 stops supplying power to the mobile device 200.

The input/output controller 16 waits to receive the authentication data transmitted by the mobile device 200 through the control line (CBUS) of the MHL cable 300 (Step S14). When the input/output controller 16 receives the authentication data (YES at Step S14), the authentication module 403 performs an authentication process on the source device based on the authentication data (Step S15), and determines whether or not the authentication is successfully completed (Step S16).

When the authentication of the mobile device 200 is successfully completed (YES at Step S16), the authentication module 403 sends the continue power supply command to the power controller 402, and the power controller 402 continues supplying power to the mobile device 200 (Step S17). At this time, the authentication module 403 sends the disable timer command to the timer module 404, and the timer module 404 stops measuring the timer period.

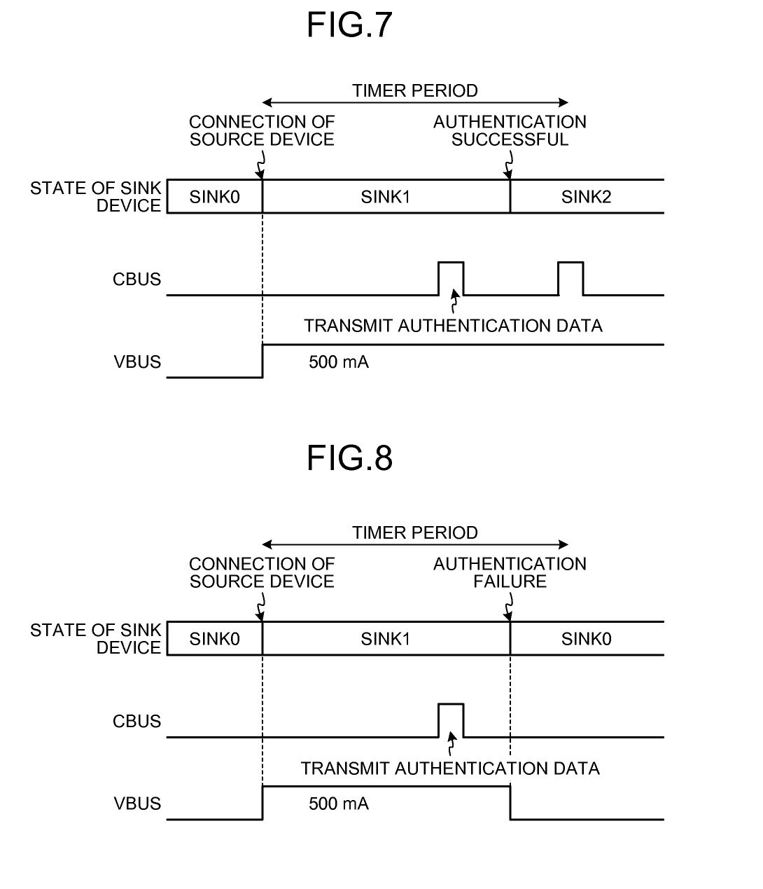

For example, as illustrated in FIG. 7, when the detector 401 detects connection of the source device (the mobile device 200), the power controller 402 supplies power of 500 mA to the source device through the power source line (VBUS). If the authentication module 403 has successfully completed the authentication of the source device based on the authentication data received through the control line (CBUS), the power controller 402 continues supplying power of 500 mA to the source device through the power source line (VBUS).

Referring back to FIG. 6, when the authentication of the mobile device 200 fails at Step S16 (NO at Step S16), the authentication module 403 sends the stop power supply command to the power controller 402, and the power controller 402 stops supplying power to the mobile device 200 (Step S19).

For example, as illustrated in FIG. 8, when the detector 401 detects connection of the source device (the mobile device 200), the power controller 402 supplies power of 500 mA to the source device through the power source line (VBUS). However, if the authentication module 403 has failed the authentication of the source device, the power controller 402 stops supplying power of 500 mA to the source device through the power source line (VBUS).

Referring back to FIG. 6, when the authentication data is not received at Step S14 (NO at Step S14), the authentication module 403 determines whether or not the timer period set by the timer module 404 has expired (Step S18). When the timer period has not expired (NO at Step S18), the process returns to Step S14 to wait to receive the authentication data.

On the other hand, when the timer period has expired at Step S18 (YES at Step S18), the timer module 404 sends the stop power supply command to the power controller 402, and the power controller 402 stops supplying power to the mobile device 200 (Step S19).

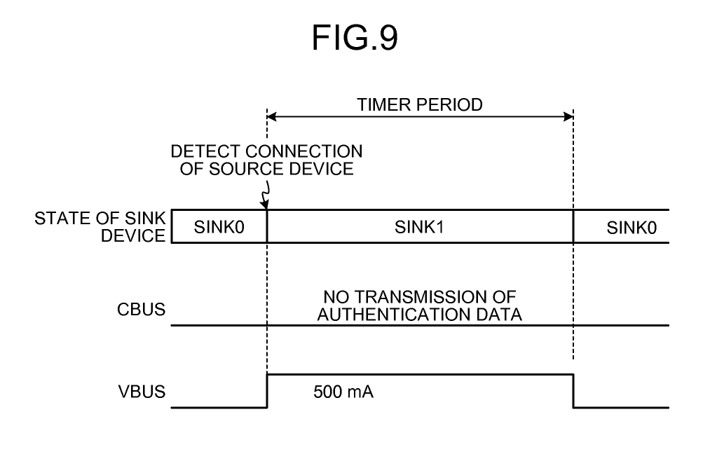

For example, as illustrated in FIG. 9, when the detector 401 detects connection of the source device (the mobile device 200), the power controller 402 supplies power of 500 mA to the source device through the power source line (VBUS). However, if the timer period has expired without transmission of the authentication data from the source device through the control line (CBUS), the power controller 402 stops supplying power of 500 mA to the source device through the power source line (VBUS).

As described above, according to the embodiment, power supply to the mobile device 200 is started after the digital television 100 serving as the sink device detects connection of the mobile device 200 serving as the source device to the MHL cable 300. Therefore, it is possible to prevent wastage of power and realize power saving with efficient use of power.

Furthermore, according to the embodiment, the authentication of the mobile device 200 serving as the source device is performed even after the power supply is started, and the power supply is continued if the authentication is successfully completed but the power supply is stopped if the authentication fails. Therefore, even if an invalid device is connected to the connector of the MHL cable 300, it is possible to prevent the invalid device connected to the sink device from being used by stopping the power supply. Consequently, it is possible to further enhance the security.

To prevent the invalid device connected to the sink device from being used, it may be possible to start power supply after the authentication of the source device is successfully completed. In this case, however, if a device with low battery, a device with dead battery, or a device that operates with power supplied by other device is connected as the source device to the sink device via the MHL cable 300, the device cannot transmit the authentication data to the source device due to the shortage of power even if the device is a valid device. Therefore, the sink device cannot perform the authentication process, so that power cannot be supplied from the sink device to even a valid source device.

To prevent the disadvantage as described above, according to the embodiment, the mechanical switch 311 is provided that turns on upon connection of the source device to the connector 310 of the MHL cable 300 on the source device side. Therefore, even when a device with low battery or a device that needs power supplied by other device as described above is connected as the source device to the connector 310, it is possible to detect connection of the source device on the sink device side. Furthermore, according to the embodiment, when connection of the source device is detected, the power supply to the source device is temporarily started to perform the authentication process. Therefore, even the source device with low battery or the like can transmit the authentication data to the sink device with the power supplied by the sink device, so that the sink device can perform the authentication process. Therefore, according to the embodiment, it is possible to enable the device with low battery or the like to perform the authentication process, enabling to enhance the security.

Meanwhile, a power control program executed by the digital television 100 of the embodiment is provided by being stored in the ROM 13 or the like in advance.

The power control program executed by the digital television 100 of the embodiment may be provided by being recorded in a computer-readable recording medium, such as a compact disc-ROM (CD-ROM), a flexible disk (FD), a CD-recordable (CD-R), or a digital versatile disk (DVD), in an installable or an executable file format.

Furthermore, the power control program executed by the digital television 100 of the embodiment may be stored in a computer connected to a network, such as the Internet, and provided by being downloaded through the network. The power control program executed by the digital television 100 of the embodiment may be provided or distributed through a network, such as the Internet.

The power control program executed by the digital television 100 of the embodiment has a module structure comprising the above modules (the detector 401, the power controller 402, the authentication module 403, the timer module 404, and the like). As actual hardware, the controller 10 (processing unit) reads a communication program from the ROM 13 and executes the communication program, so that the modules are loaded into the RAM 12, and the detector 401, the power controller 402, the authentication module 403, the timer module 404, and the like are generated on the RAM 12.

The embodiments are not limited to the specific forms as described above, and may be embodied in other forms by modifying components within the scope of the embodiment. Furthermore, various embodiments may be embodied by appropriately combining any components described above. For example, certain components described in the embodiment may be removed. For another example, components described in different embodiments may be combined appropriately.

Exemplary modifications will be described below. In the embodiment, power supply to the source device is stopped immediately after the authentication module 403 fails the authentication of the source device. However, the power controller 402 and the authentication module 403 may be configured such that even when the authentication of the source device fails, the authentication data is received from the source device again and the authentication process is performed before the timer period expires, and the power supply to the source device is stopped if the authentication fails before the timer period expires.

In the embodiment, an example is explained in which a protocol based on the MHL standard is used as the video transmission technology. However, the protocol of the video transmission technology is not limited to this example. For example, the digital television 100 and the mobile device 200 may be configured to use a protocol based on the HDMI standard as the protocol of the video transmission technology. In this case, it is sufficient that the sink device, such as the digital television 100, and the source device, such as the mobile device 200, are connected via an HDMI cable and also connected via a power source cable for supplying power to control power supply in the same manner as the embodiment.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device connectable to a source device, the communication device comprising:
a detector configured to detect connection of the source device by detecting an on-state of a connector, the connector being configured to mechanically enter the on-state upon connection of the source device;
a power controller configured to start supplying power to the source device through a cable when the connection of the source device is detected; and
an authentication module configured to perform authentication of the source device based on authentication data received from the source device after the power supply is started, wherein
the power controller is configured to continue supplying power to the source device when the authentication of the source device is successfully completed.

2. The communication device of claim 1, wherein when the authentication of the source device fails, the power controller is configured to stop supplying power to the source device.

3. The communication device of claim 1, further comprising:
a timer module configured to measure a predetermined time since a start of the power supply when the connection of the source device is detected, wherein
the power controller is configured to stop supplying power to the source device when the power controller does not receive the authentication data from the source device within the predetermined time.

4. The communication device of claim 1, wherein the power controller is configured to stop supplying power to the source device when the connection of the source device is not detected.

5. A communication system comprising:
a sink device; and
a cable configured to connect the sink device and a source device, wherein
the cable comprises:
a first connector configured to connect the sink device; and
a second connector configured to mechanically enter an on-state upon connection of the source device, and
the sink device comprises:
a detector configured to detect connection of the source device by detecting the on-state through the cable;
a power controller configured to start supplying power to the source device through the cable when the connection of the source device is detected; and
an authentication module configured to perform authentication of the source device based on authentication data received from the source device after the power supply is started, wherein
the power controller is configured to continue supplying power to the source device when the authentication of the source device is successfully completed.
